(19) United States
(12) Patent Application Publication
(10) Pub. No.: US 2012/0117003 A1
(43) Pub. Date: May 10, 2012

(54) Geoengineering Method Of Business Using Carbon Counterbalance Credits

(76) Inventor: David A. Benaron, Portola Valley, CA (US)

(21) Appl. No.: 12/942,701

(22) Filed: Nov. 9, 2010

(51) Int. Cl. G06Q 90/00

(52) U.S. Cl. 705/500

(57) ABSTRACT

A business method for providing an emissions trading approach value to products and services that provide active cooling of the Earth that provides a sustainable means for global cooling strategies to achieve commercial value, in order to drive development and real-world application of these approaches, comprising the steps of manufacturing a light-scattering nanoparticle (527), deploying the stratospheric nanoparticles for reducing solar radiation incident on the Earth (537), receiving Carbon Counterbalance Credits in exchange for the local, national, regional, or international benefits derived from said deployment (547), and derives income from selling said credits in order to create a sustainable and viable business (557). Systems, devices, and agents for deployment in accordance with the business method are also disclosed.

### CROSS-REFERENCE TO RELATED APPLICATIONS

This application claims priority to U.S. Patent Application No. 61/252,041, filed Nov. 12, 2009, entitled “Geoengineering Method Of Business Using Carboe Counterbalance Credits,” which is hereby incorporated herein in it's entirety by reference.

### FIELD OF THE INVENTION

The present invention relates generally to a business method for providing an emissions trading approach value to products and services that provide active cooling of the Earth which provides a sustainable means for global cooling strategies to achieve commercial value, in order to drive development and real-world application of these approaches, and more particularly relates to a business method in which a company deploys stratospheric light-scattering nanoparticles for reducing solar radiation incident on the Earth, receives Carbon Counterbalance Credits in exchange for the local, national, regional, or international benefits derived from said deployment, and derives income from selling said credits in order to create a sustainable and viable business.

### BACKGROUND INFORMATION

It is probably too late to stop global warming through conservation and use of alternative energy sources. Even if all industrialized societies could switch today to net-zero greenhouse methods, the Earth will likely inexorably continue to warm for decades, if not for centuries.

In order to encourage and promote a rapid reduction in both worldwide carbon production and atmospheric carbon levels, carbon credits have been introduced as a key component of national and international economic and regulatory policy strategies intended to mitigate and then reverse growth in concentrations of greenhouse gases. In this system, greenhouse gas emissions are capped, and then markets are used to allocate the emissions among the group of regulated sources. Emission credits are a regulated or voluntary currency of limited circulation size which can be used to reward those reducing greenhouse gas production or levels in manufacturing or consumption, while requiring those who exceed recommended or capped production greenhouse gas levels to buy these same tradable emission units from recipients of the credits, in order to be allowed to exceed the same emission recommendations or caps. This forced purchase of credits makes those products that excessively release carbon in their manufacture or use incrementally more expensive, and provides market-leveling cost reduction to green business models and strategies that raise manufacturing or usage costs. As an example, if credits are balanced, the cost of green energy, for example, becomes competitive with hydrocarbon-based energy; policy or market forces can also permit a certain cost advantage to the consumer for the same green energy.

Typically, a carbon credit is equal to permission to release one ton of Carbon. The idea is to allow market mechanisms to drive industrial and commercial processes in the direction of low emissions or less “carbon intensive” approaches than are used when there is no cost to emitting carbon dioxide and other greenhouse gasses into the atmosphere. Since greenhouse gas mitigation projects generate credits, this approach can be used to finance carbon reduction schemes between trading partners and around the world.

There are currently two distinct types of Carbon Credits: Carbon Offset Credits (COCs) and Carbon Reduction Credits (CRCs). Carbon Offset Credits are provided for clean forms of energy production, wind, solar, hydro and biofuels. These clean forms of energy and determining their carbon credit value is known in the art, including US 2008/0042790, JP 2007080299 and others. Activities that benefit from Carbon Reduction Credits include collection and storage of carbon from our atmosphere through reforestation, forestation, ocean and soil collection and storage efforts. Carbon offset methods are also known in the art, and include carbon dioxide sequestering approaches such as U.S. Pat. No. 6,890,497, WO 2009/092718, and others. Both approaches are recognized as effective ways to reduce global warming by a reduction in greenhouse gasses.

Carbon trading is just one specific application of an emissions trading approach. However, note neither of the current credits directly counters the actual incident radiant energy coming from the Sun to Earth.

An alternative strategy is global cooling. Global cooling is a once-fringe strategy initially proposed by Wigley (Wigley 1992), Teller (Teller 1997), and others as a form of climate control, sometimes referred to as geoengineering, or even as Terraforming. In this approach, the light and heat budget of the planet is actively managed, rather than managing the carbon emissions and levels. Ultimately, a mixed approach of both geoengineering and greenhouse gas reduction or storage is likely to be the best policy. However, changing the climate through active geoengineering does not yet fit into this equation of Carbon Offset or Reduction Credits, or into other emissions trading approaches.

What is needed is a method to provide value to contribution of global cooling, for which we introduce a new carbon credit called Carbon Counterbalance Credits (or CCCs).

### SUMMARY OF THE INVENTION

We propose that the act of global cooling can be assigned a carbon-tonnage value, similar to tons of carbon used in setting the value of current carbon credits. For example, a certain amount of global cooling reduces the heating of the earth in the same manner as reduction in a ton of carbon over its lifetime in the atmosphere. Such calculations of cooling have been performed in the past, but the translation into established emissions trading schemes has not occurred.

By creating a system of carbon counterbalance credits, a global cooling business can be assigned a business value, encouraging investment in this area, and the resultant global cooling business can become a sustainable business.

### BRIEF DESCRIPTION OF THE DRAWINGS

The breadth of uses and advantages of the present invention are best understood by example, and by a detailed explanation of the workings of a proposed commercial method and its associated systems, devices, or methods described herein. Additionally, some of the agents have been tested under laboratory studies described herein. These and other advantages of the present invention will become apparent upon consideration of the following detailed description, taken in conjunction with the accompanying drawings, in which like reference characters refer to like parts throughout, and in which:

FIG. 1 shows a simplified schematic of radiant energy flow from the sun to the Earth circa 1880 A.D.

FIG. 2 shows the same radiant energy flow schematic, only now for a future year, in 2100 A.D., when the increases in greenhouse warming gasses have continued to alter and increase the absorbance on Earth of radiant energy from the sun, thus raising the average global temperature.

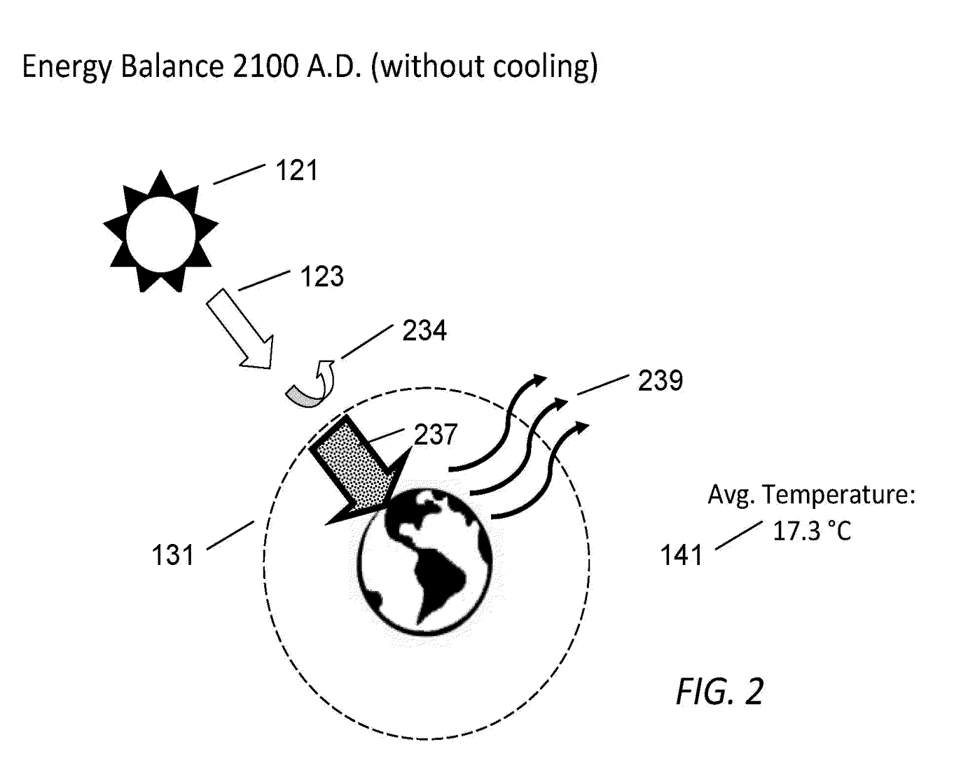

FIG. 3 shows the same radiant energy flow schematic as for FIG. 2 for 2100 A.D., only now with geoengineering effected by the placement of light scattering particles into the atmosphere, thus reducing the absorbance of radiant energy in the atmosphere, and leading to normalization of global temperature to that of the same year, 1880 A.D., illustrated in FIG. 1.

FIG. 4 is a schematic flow chart of the business method for green products that reduce global warming using a typical emissions trading approach in which a green product receives both income from both sales as well as carbon credits, and wherein the profit from carbon credits creates a market-leveling economically competitive or economically advantageous price for the green product.

FIG. 5 is a flow chart of the business method for global cooling products or services of the present invention, in which a product that leads to global cooling receives income primarily from the sale of carbon counterbalance credits because the primary business service is the delivery and deployment of material into the atmosphere, and there is little or no direct-to-consumer product to offer.

### DEFINITIONS

For the purposes of this invention, the following definitions are provided:

Global Warming: A general warming trend of the Earth's environment, and in current use specifically refers to the increase in the average global temperature of the Earth's near-surface air and oceans since the mid-20th century due to climate forcing by greenhouse gasses, and its includes both a projected continuation into the future without action to control it, as well as a perception of severe consequences for life and civilization on Earth if unchecked.

Global Cooling: As used herein, an active method for reducing the energy incident on the Earth, its land, its oceans, or its atmosphere, with a resultant decrease in the average global temperature (or at least a decrease in the rate of the rise in global temperatures). Historically, global cooling refers to a natural general cooling trend of the Earth, and this context is not intended for the purposes of this invention. Rather, here, global cooling is an active effort to reduce global temperatures through methods, systems, devices, and agents.

Geoengineering. An engineering process by which a planet's climate is modified by methods, systems, devices, or agents. Geoengineering is usually taken to mean device, systems, or agent-based engineering approaches, to deliberately manipulate the Earth's climate to counteract global warming through changes in the solar radiation incident upon the Earth. Geoengineering can stand alone and force global cooling, or it can readily be deployed alongside greenhouse gas reduction approaches to produce a hybrid approach. Many scientists believe that this hybrid approach may be required to effect near-term rapid reductions in global warming; in contrast, some scientists are adamantly opposed to geoengineering or believe that real-world deployment of global cooling should be delayed until our understanding and climate modeling improves.

Terraforming: A process by which a planet's climate and environment is made more habitable for Earthly creatures. Typically, this term is applied to extra-terrestrial sites for the transformation of an environment hostile to Earth-based life forms; in this case it can be applied to the Earth as well to efforts to make Earth's own climate more habitable, stable, and conducive to life for Earth's present inhabitants, in contrast to the changed, warmer, and likely less habitable world for current civilization that is envisioned if global warming continues unchecked.

Emissions Trading Approach. A method of providing capped greenhouse gas production, and at the same time issuing credits to those companies whose products reduce the rate or amount of global greenhouse gas emissions. These credits may then be sold or traded to companies who do not meet the emissions standards, thus giving them permission to exceed the stated limits, or to groups that voluntarily by credits for altruistic, political, or economic reasons. The net effect results in an offset or reduction in the cost of manufacturing green products for those companies receiving emissions credits, and a net increase in the cost of producing or manufacturing for those companies with a product that is more polluting. This can level the cost difference between green and non-green products, or can provide favorable pricing for the more green products, depending on policy and economic forces (including even carbon credit futures trading and speculation). As noted, there are also companies that sell carbon credits to commercial and individual customers who are charitably interested in lowering their carbon footprint on a voluntary basis. Voluntary credits typically have less commercial value than the units sold through the rigorously-validated clean development mechanisms, such as credits for wind or solar energy production.

Carbon Credit. A tradable credit of limited availability used to mitigate growth in concentrations of greenhouse gases. One carbon credit is typically equal to one ton of carbon. Currently there are two distinct types of carbon credits: Carbon Offset Credits (COCs) and Carbon Reduction Credits (CRCs). In the present inventive business method, we introduce a new type of Carbon Credit, the Carbon Counterbalance Credit, with a value based upon the amount of carbon that would needed to be removed in order to produce an equivalent reduction in average global (or regional) temperature.

Carbon Counterbalance Credit. A carbon credit that is based upon the amount of carbon that would need to have been counteracted (e.g., removed from the atmosphere) in order to produce an equivalent reduction in average global (or regional) temperature. A Carbon Counterbalance Credit is distinguished from a Carbon Offset Credit in that in counterbalance the carbon has not, in fact, been removed from the atmosphere; rather, the incident radiation upon the Earth's surface has been decreased.

Nanomaterial. Materials manufactured or created to have at least one dimension (width, length, diameter, or structured feature) less than 100 nm in size. Nanomaterials may be a structured rod called a nanorod, a structured tube called a nanotube, a carbon cage or ball such as a fullerene, a powder with particle size under 100 nm called a nanopowder, a crystal with called a nanopowder

### DETAILED DESCRIPTION OF EMBODIMENTS OF THE INVENTION

The foregoing descriptions of specific embodiments and best mode of the present invention have been presented for purposes of illustration and description only. They are not intended to be exhaustive or to limit the invention to the precise forms disclosed. Specific features of the invention are shown in some drawings and not in others, for purposes of convenience only, and any feature may be combined with other features in accordance with the invention. Steps of the described processes may be reordered or combined, and other steps may be included. The embodiments were chosen and described in order to best explain the principles of the invention and its practical application, to thereby enable others skilled in the art to best utilize the invention and various embodiments with various modifications as are suited to the particular use contemplated. Further variations of the invention will be apparent to one skilled in the art in light of this disclosure and such variations are intended to fall within the scope of the appended claims and their equivalents. The publications referenced above are incorporated herein by reference in their entireties.

### EXAMPLE 1

### Comparison of Business Methods for Countering Global Warming by Greenhouse Reduction Versus Causing Global Cooling by Geoengineering

In this example, global warming and global cooling business methods are compared and contrasted, in order to better understand the case for the inventive business method.

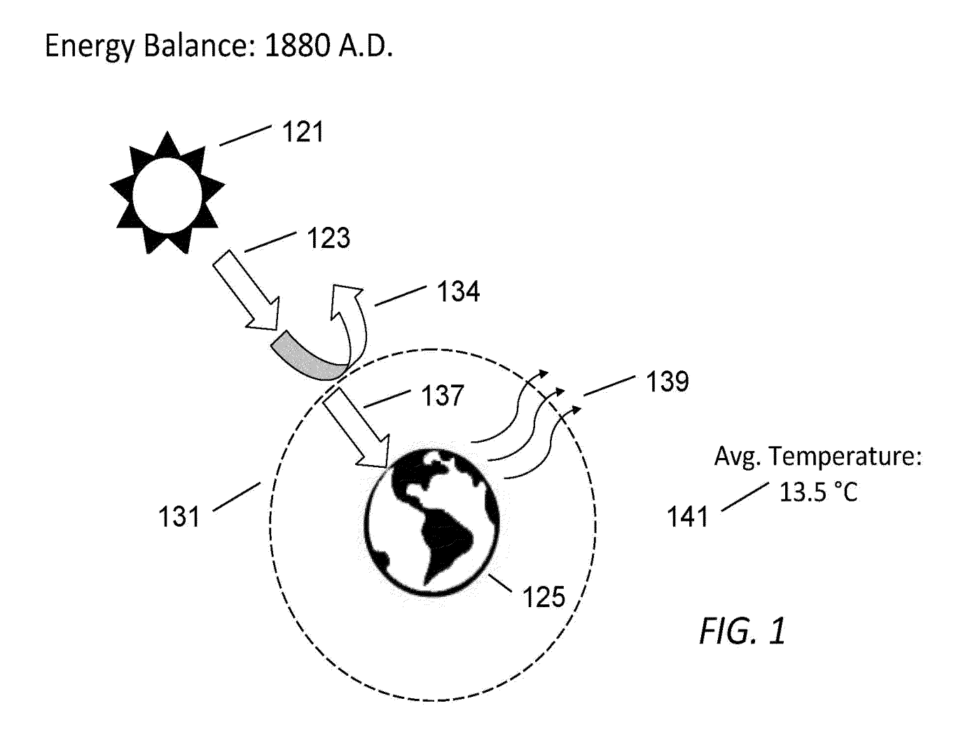

To begin, a schematic of the Earth's Energy Balance as it appeared in 1880 A.D. is shown in FIG. 1. At this earlier time, the mean global temperature was reported as 0.4° C. below the 20th Century mean global temperature of 13.9° C., or at about 13.5° C. In this schematic, sun 121 radiates energy 123 toward Earth 125. Earth 125 is surrounded by atmosphere 131. As a result of light scattering by the Earth's land, ice, snow, oceans, atmosphere, and the like, some of energy 123 is directly radiated back into space as returned energy 134, without absorbance or transformation steps for energy 134. The remainder of energy 123 reaches Earth as absorbed (or captured) energy 137, which can be thermally absorbed in the atmosphere, on land, or in water, ice, or snow, or at other sites, captured in chemical bonds (e.g., in ozone, photosynthesis, oil, or other energy containing substances), or otherwise stored or captured. The absorbance of this energy typically causes the Earth to warm, and warming continues until the flow of radiated energy 139 leaving the Earth, and the flow of captured and absorbed energy 137 are balanced. In this particular example shown in FIG. 1, balance is reached when the planet's surface reaches an average (or mean) global temperature 141 of 13.5° C.

Of course, this schematic is a highly simplified model, and the actual energy flow is convoluted and complex, involving heat and mass flow, state changes, chemical changes, variations in albedo. For example, there are many ways for the energy to be absorbed, with the thermal energy locked for later release into chemical bonds in ozone or incorporated into food or oil. Those skilled in the art will recognize the broader and more extent and the complexity of mechanism involved in Earth's energy balance, and understand that those mechanisms fall within the present business method if they result in cooling (or reduction in the rate of warming) through a reduction in the incident radiation, rather than from a mere adjustment in the rate of greenhouse gasses. However, for the explanatory and illustrative purposes herein, this simplification remains a useful tool.

Next, we jump 120 years ahead in time to the year 2100 A.D. If the Earth stays on its present course of global warming, a schematic of Earth's projected energy balance in the year 2100 A.D. illustrates significant changes in the Earth's energy balance, as shown in FIG. 1. Here, sun 121 once again radiates energy 123 toward Earth 125, and Earth 125 remains surrounded by atmosphere 131. However, energy absorbed 237 is markedly increased (indicated by the larger arrow as compared to 1880 A.D. level of energy absorbed 137). This increase in energy absorbed 237 is due in large part to a higher concentrations of greenhouse gasses, as well as due to other changes this warming has induced, such as a reduced reflectivity (albedo) of the polar ice caps once they have turned to slush and/or melt water. As a result of this increased absorbance and increased capture and thermal trapping, there is also a large decrease in returned energy 234 (as compared with the returned energy 134 shown in FIG. 1 for 1880 A.D). This large increase in absorbed energy causes the Earth to warm, until the increased in the rate of energy 237 being absorbed is once again in balances an increase in the flow of radiated energy 239 leaving the Earth. As a result, the planet's surface settles at a higher average global temperature 241 of 17.3° C. Of note, this temperature was predicted using an average of a range of values determined from published models and calculations of global warming from different climate models, each however assuming that no action is taken to reduce emissions and regionally divided economic development.

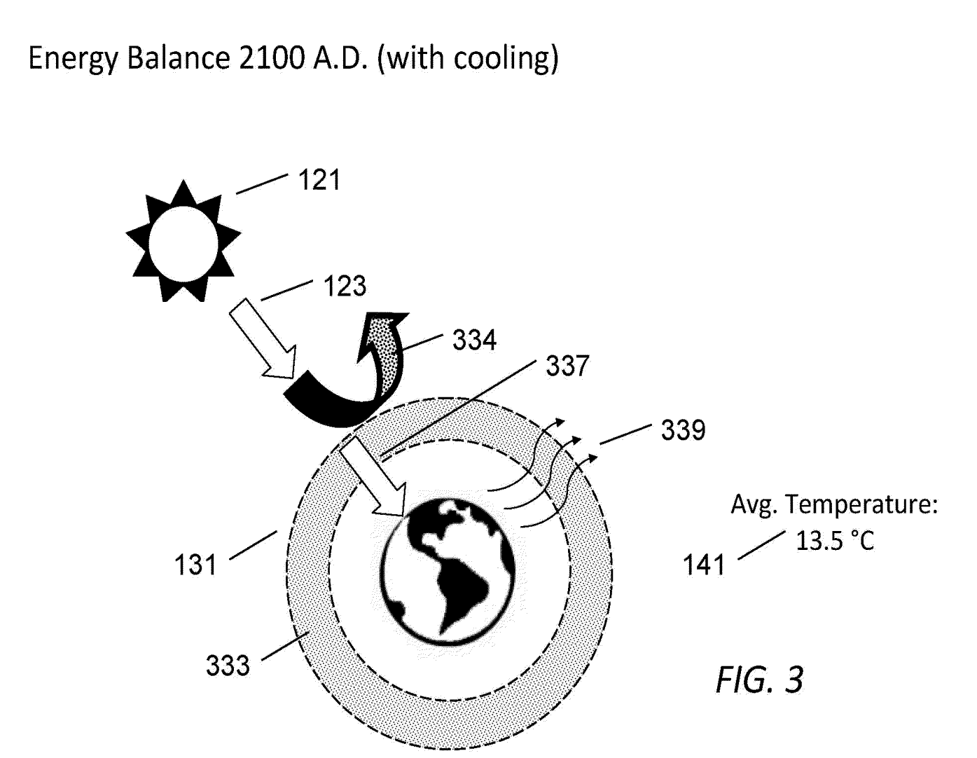

Last, consider the implementation of global cooling through the release of light scattering polymer or mineral particles high into the Earth's atmosphere. We start again with a schematic energy balance in the year 2100 A.D., only this time in the presence of significant geoengineering efforts, as shown in FIG. 3. Here, sun 121 again radiates energy 123 toward Earth 125. Earth 125 remains surrounded by atmosphere 131, only this time atmosphere 131 also contains light scattering particle cloud 333 in the stratosphere, where the 1-2 micron particles may stay suspended for years. These particles were placed there by high flying jets, special rockets or balloons, or other methods, and remain aloft for a period of days to months to years, as will be described in more detail in a later Example. As a result of the increased scattering of energy 123 by cloud 333, the amount of radiant energy returned 334 from the Earth without absorbance is increased (perhaps by as much as 1-3% or more, as compared to returned energy 134 and 234 in the prior figures). Consequently, absorbed energy 337 is also reduced, perhaps down to level 137 last seen in the schematic for 1880 A.D., despite the presence of greenhouse gasses, and due to the increased energy deflected or scattered as returned energy 334. As a net result, the Earth receives less total energy to absorb, and the Earth cools (or warming slows) until the flow of radiated energy 339 leaving the Earth and the flow of absorbed energy 337 reaching the earth are once again in balance. This results in the planet's surface falling, and settling at the original 1880 A.D. average global temperature 141 of 13.5° C.

Again, the cooling model is simplistic. Reductions in incident solar radiation can have many effects, including reduce crop yields, reduces the benefit of solar and wind energy systems by reducing the total energy reaching the Earth. However, the net result of global cooling efforts is that the Earth's average global temperature is reduced, or the rate of warming slows, or even that at least the average temperature of a target region is reduced as compared to the level that would otherwise have been reached given the level of greenhouse gases in the atmosphere. This, in conjunction with the maintenance of polar and glacial ice, and other factors, will have a benefit of stabilizing the climate at a cooler point.

Note also that the global temperature rise is reduced, stabilized, or eliminated without any required reduction in greenhouse gasses. Such greenhouse gasses such as carbon dioxide may have other effects if not reduced (acidification of oceans, for example); however, the global warming temperature effect has been modulated by a reduction in the total energy available for absorption.

There are other methods of reducing incident radiation. For example, modifying surfaces (e.g., floating large Mylar reflectors in the sea, white roads and rooftops, and others) as well as space-based methods (addressable, individually and remotely pointable mirrors, Mylar sheets, and others), in addition to the stratospheric light-scattering methods detailed here. All such methods fall within the present invention if the costs of the projects do not deliver a sellable commercial product, and instead (or in addition to) being paid for using emission credits for incident radiation reduction (such as Carbon Counterbalance Credits) that can be traded for tangible value or property.

### EXAMPLE 2

### Traditional Green Method Versus Instant Business Method

A case study will make now make the business method more clear.

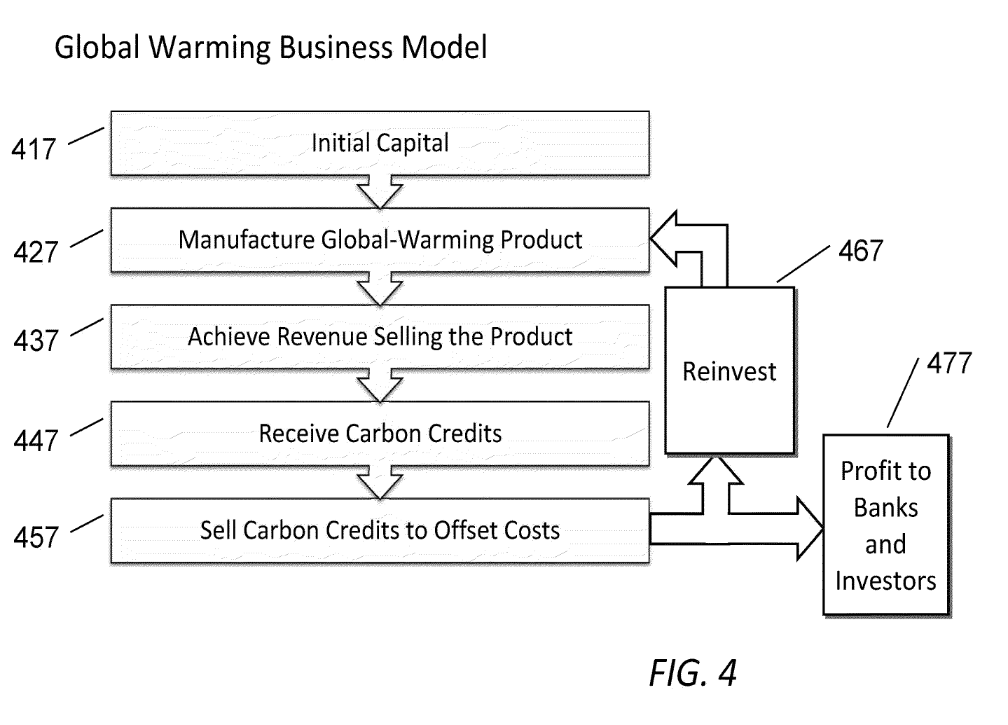

One of many possible flow charts for operation of a hypothetical business called GreenCo is shown in FIG. 4. GreenCo begins with capital at step 417 to start the green business, and their green product is soon manufactured at step 427.

In this example, a green product is made by GreenCo, such as electric energy from the wind, which can then be sold to a customer such as a local energy delivery company like Pacific Gas and Electric in California. As is typical, a green product costs more to manufacture than less green products such as electricity produced from coal. In order to level the playing field, and encourage products that reduce global warming, a carbon credit scheme providing carbon credits to green energy firms is established by a second party, such as government or regulatory body. Currently, these tradable carbon credits are typically provided at a rate that one credit equals a ton of carbon saved through the manufacturing of the green product. Such emissions trading units are limited in supply, and provided without significant cost to the green business.

A key step is that GreenCo sells their green product for revenue, such as delivering electricity from solar or wind energy to an energy delivery company, at step 437. Despite the sale of the energy, however, this does not fully make the product commercially self-sustaining or sufficiently profitable. GreenCo also receives carbon credits at step 447. GreenCo now can achieve incremental and additional revenue by selling the carbon credits to a third party at step 457, thus completing the business transaction of selling green energy in a manner that leads to a sustainable business and a going concern.

The company that purchases these credits from GreenCo also produces products (e.g., electricity from the burning of coal, releasing significant greenhouse gasses) but this product is less expensive to produce that GreenCo's product. This company becomes the third party that buys one credit for every ton of extra carbon released above the legal caps, thereby increasing the cost of their less-green product. This can completely even out the price difference between the green and dirty products, and even provide a cost advantage for the green product, which in turn provides a financial incentive for customers to adopt and purchase the greener product.

At this point, GreenCo can take the funds received from the sale of the product and the sale of carbon credits and reinvest these at step 467 to sustain the business cycle, and (if this is a for profit business, which is not required), some profit can also be returned to banks and investors, and the like, at step 477.

Now, a contrast can be made to the inventive business method.

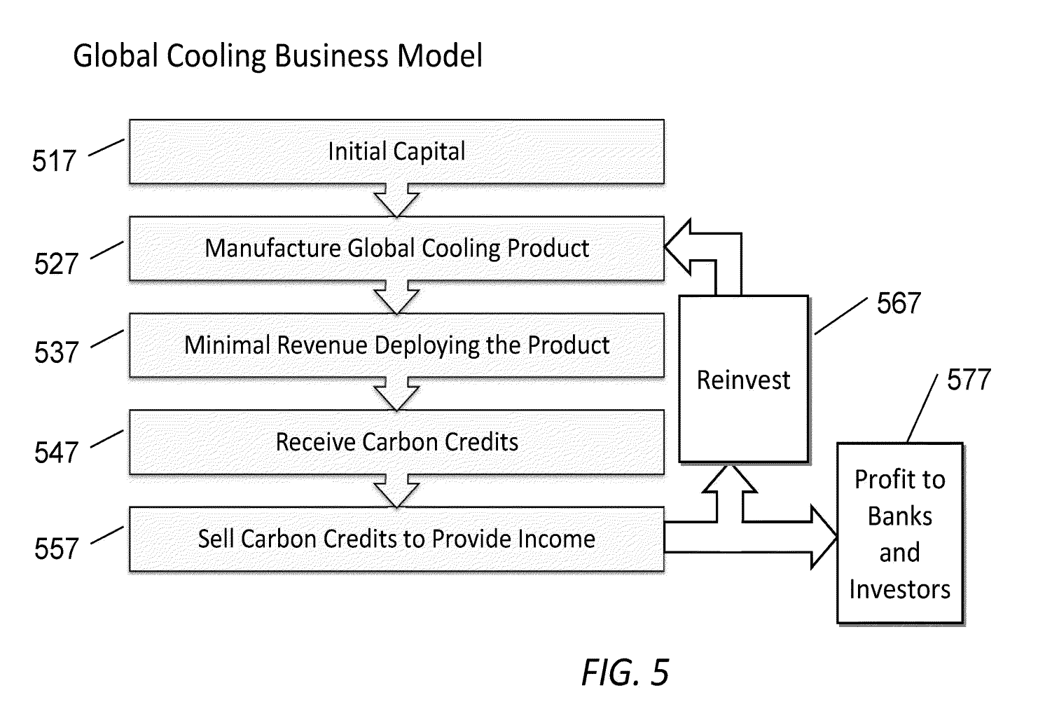

A possible flow chart for the operation of a hypothetical global cooling business called CoolCo is shown in FIG. 5. As in the last example, CoolCo begins with an investment of initial capital, at step 417, to start the business or the service line. Next, a green product is manufactured at step 427, again similar again to the steps taken by GreenCo.

Now the difference begins to be seen. CoolCo deploys its product, on the ground, into the atmosphere, or into space at step 537. While it is possible that a local, regional, or governmental agency pays for this as a service, more likely is that unlike for GreenCo there may be no direct buyer of the CoolCo product or service. From a business perspective, this makes it difficult for CoolCo to be commercially self-sustaining, or even to sell its product or service.

CoolCo now receives carbon counterbalance credits at step 547 for its downward movement of the average global temperature (for an equivalent amount of carbon that would have to be removed to cause as similar slowing of the rise or a drop in global temperature), rather than for providing a cleaner product or service. Rather, the effect of the CoolCo product on the environment is compared to how many tons of carbon would need to be removed in order to achieve that level of cooling, and this is converted into carbon credits, one credit per ton of carbon removal equivalent climate effect. This carbon credit we term a Carbon Counterbalance Credit.

CoolCo now achieves tangible revenue by selling these carbon counterbalance credits at step 557, thus completing the business transaction. As with any green business model involving emissions credits, these credits are provided to CoolCo (the first party) by a regulatory or government body (the second party), and then these credits are sold to a dirty company (the third party) seeking to be allowed to continue to produce the dirty product (or another type of third party buyer), thereby increasing the cost of the dirty product. However, in contrast to GreenCo, CoolCo likely receives the majority of its revenue from the sale of its carbon credits.

Note again that there may be no additional product or service remaining to sell to a customer after the service is performed or the product is deployed, and there may not even be a specific customer to whom the cooling product's sale is targeted. Instead, a transformation occurs in which a product is synthesized (a chemical or mineral changed into a deployable product), deployed (transformed from bulk agent to atmospheric agent) while at the same time a carbon credit is established from the climate value of the deployment itself. Again, the regulatory body issues carbon counterbalance credits based upon a global impact value using climate, economic, and political metrics to value to conversion. Finally, the carbon credits are traded or sold by CoolCo, allowing for a sustainable and going business.

### EXAMPLE 3

### Application of the Business Method To Doing Business with a Multinational Regulatory Body

A multinational regulatory body that issues carbon credits may have many reasons for wishing to promote global cooling, including international food supply integrity, social stability, political stability, altruism toward all peoples of the world, and others.

In this example, the present method of business as it applies to doing business with a regulatory body is discussed. Body A could reasonably be a local, state, federal, multi-national, or an international regulatory body. Here, a hypothetical regulatory body that issues carbon credits, called Body A, has expressed an interest in inducing global cooling through the use of geoengineering.

In this example, CoolCo (the first party) is again a global cooling company performing the business method through modification of the light scattering properties of the stratosphere. Body A (the second party), wishing to take action on global warming, promises to provide tradable emission credits to CoolCo.

CoolCo now finances, manufactures, and deploys a global cooling agent. In exchange, CoolCo receives the promised carbon credits, equivalent to a specified tonnage of reduction of greenhouse gas levels. The rate of credit may be set based upon a cooling determination that could be deployment specific, such as measuring the reduction in incident radiation on the Earth using actual measurements made after deployment, or the rate may alternatively be based on historical, political, or economic metrics or models. Other methods of determining the ideal valuation can be envisioned by those skilled in the art.

CoolCo now sells these emission credits locally, statewide, regionally, nationally, or internationally to a third party seeking to offset their own greenhouse emissions. Ideally, the net effect of the additional greenhouse gasses produced by the third parties is more than completely counteracted, with the result of a complete counterbalance with excess cooling and a reduction in average global temperature.

The value of global cooling to the governments represented in Body A may be sufficiently compelling that additional incentives such as direct payments, tax breaks, or other standard business transactions or incentives may be applied in addition to tradable emissions credits.

### EXAMPLE 4

### Application of the Business Method to Doing Business with Government Acting Unilaterally

A government, like a regulatory agency, may have many reasons for wishing to promote global cooling, from self-interested preservation of the status quo, including food supply integrity and social stability, to altruism toward all peoples of the world. However, unlike a multinational effort, a single government may choose to act alone when other governments cannot make a decision or are unable to reach agreement as a group.

In this example, the method of business as it applies to doing business with single government acting unilaterally through global hegemony is contemplated. Here, a hypothetical government called Government A has expressed an interest in reducing global warming, while another hypothetical government called Government B refuses to halt its growth or curb emissions. Government A could be a local, state, federal, multinational, or world government body. However, without the cooperation of both Governments A and B, a true reduction in emissions sufficient to counteract global warming is not achievable. This leaves Government A without options under normal global warming business models.

In contrast, consider that a unilateral action is sufficient to achieve global cooling. For example, CoolCo (the first party) is again a global cooling company performing the business method. Government A (the second party), wishes to take action on global warming, and promises to provide tradable carbon counterbalance credits to CoolCo. Alternatively, or in addition, Government A could promise cash payments for services rendered.

CoolCo now finances, manufactures, and deploys a global cooling agent. In exchange, CoolCo receives the promised carbon credits, equivalent to a specified tonnage of reduction of greenhouse gas emissions. CoolCo now sells these emission credits locally, statewide, regionally, nationally, or internationally to a third party seeking to offset their own greenhouse emissions.

Note that the value of CoolCo's climate change to Government A may be sufficiently compelling that additional incentives such as direct payments, tax breaks, or other standard business transactions or incentives may be applied in addition to tradable emissions credits. For example, Government A could be an oil producing country seeking to maintain its exports of petroleum based products, or Government A could be a global power who wishes to enforce global cooling through unilateral and global hegemony.

### EXAMPLE 5

### Application of the Business Method to Doing with a Company

In this example, a business method for working with a company is contemplated.

A hypothetical greenhouse gas producing company, called OilCo wishes to maintain its worldwide market. OilCo agrees, or alternatively multiple OilCos in a cartel all agree, to purchase a large number of carbon credits from CoolCo.

Again, CoolCo now manufactures and deploys sufficient light scattering material to drop the Earth's average temperature by some specified temperature. In exchange, CoolCo may receive payment from OilCo for providing a service. Further, CoolCo receives emission credits, and CoolCo the sells these credits locally, statewide, regionally, nationally, or internationally to a third party seeking to offset their greenhouse emissions. If properly structured, the net effect of the additional greenhouse gasses produced by the third parties is reduced, counteracted, or results in an actual fall in global temperatures.

Of note, an advantage to OilCo is that it now is able to sell more of its oil based products due to a reduction in the threat of global warming.

### EXAMPLE 6

### Optical Scattering Agent and Other Devices and Agents

In this example, the agent leading to a reduction in received solar energy is considered.

Aerosolized particles are very important to the scattering of visible and near-infrared light. Current normal atmospheric particulate matter represents a mass of 1-100 ug per cubic meter. At a typical level of 20 ug per cubic meter, the visibility in pure air of 340 km would fall to 43 km by addition of the particles. Any visible optical effect in the atmosphere is therefore currently dominated by particulate aerosols. Aerosolized particulates are also cloud condensation nuclei and thus are very important for the hydrologic cycle. An excess of particles from industrialization has resulted in a whitening of the blue sky, a process that would be strengthened by geoengineering approaches contemplated herein.

Teller provided some of the earliest widely read scientific papers describing the characteristics of the ideal global cooling particles. In part, this was based on transient global cooling events seen after certain cataclysmic event such as volcanic eruptions. For example, after the eruption of Mt Etna in Italy at 44 BC, the following summer was cold and the farmers could not harvest very much, and famines occurred not only in Italy but also in China. Similar temperature dips in modern times were seen after the eruption of Mt. Pinatubo.

Other groups have looked at the distribution and lifetime of particulates in the troposphere, in which particles can stay for days to weeks (with an average of one to two weeks), and of particulates lofted into stratosphere, in which particles can reside for months to years (with an average time of one year for typical aerosols currently present), especially for particles sized under 2 microns. The stratosphere is the primary reservoir of long-term particles after volcanic eruptions, with mass concentrations to 300 times higher after major volcanic eruptions than during periods of volcanic quiescence. This sets an upper limit of what is reasonably required to substantially reduce global temperatures at greenhouse levels present during those periods.

Of note, the particulate counts are substantially higher over the continental cites, and lower in the poles, suggesting that regional cooling strategies could be adopted, especially if larger particulates are released into the troposphere, where the dwell time is shorter than at higher altitudes and shorter than for smaller particles. Further, it raises the point that there is likely some modulating effect of greenhouse gasses from the particulates now emitted by industry.

When Teller in 1997 made estimates of cost, he estimated complete counterbalancing would cost approximately $5-10 billion U.S. dollars per year. More recently, Wigley calculated the impact of injecting sulfate particles, or aerosols, every one to four years into the stratosphere in amounts equal to those lofted by the volcanic eruption of Mount Pinatubo in 1991 (about 10 Teragrams of sulfur in total), and Rasch et al. estimated the cost estimated to counteract a doubling of greenhouse gasses (1.5 Teragrams of small-particle sulfur/year) to be higher, at $25-50 billion a year. Given the magnitude of global warming, even these larger costs are tractable, being similar to what the U.S. Federal Government spends annually on education (about $60 billion), and significantly less than what the U.S. Government spends annually on health care (about $700 billion in 2008).

A major limitation of many of the suggested cooling agents is their toxicities. Sulfur dioxide, responsible for several global cooling events after volcanic activity, produces a mildly acidic rain. Metal halides, such as sodium chloride, result in salty rain which can ruin farmland.

An ideal agent be neutral to the environment (not cause more harm than good), and even better would not have adverse effects beyond a light scattering effect. For example, a biodegradable light scattering polymer would provide a reasonable particle size, remains aloft for periods of days to months, and result in a sufficient haze for an increase in light scattering. One example of such an agent is polyethylene glycol. Another example is a sugar polymer or corn starch. Even ultrafine sugars have an average size of 60 microns. The manufacture of some of these agents may tax current biosphere production of the raw materials, however solar driven space production would not be subject to these limits.

Agents with a high dielectric field are strong light scatterers. Certain mineral dusts are also plausible agents, such as silicon dioxide dust, which is prevalent in the crust of the Earth. Such dusts can potentially lead to lung and skin disease, and damage airplane engines which are typically unfiltered due to the high airflow. However, Silica is an abundant mineral, and could be provided in a form that minimizes respiratory risk.

Nanoparticles may be ideal candidates for such efforts. One study showed the mean particle size in multiple samples over Athens ranged from 0.18 to 0.42 μm. Nanopowders with diameters of 5-100 nm can be made from metals, oxides, silicates, and salts. These particles are substantially smaller than the average particles normal present, and can 100 times or more surface area exposed to incoming radiant sunlight (which can be measured as square mm area per cubic centimeter volume or per gram of mass). This is also true of light scattering from sulfur particles, which come from aerosols with radii between 0.1 and 1 μm. These particles are formed by the coagulation of the smallest particles (called the “accumulation” mode). The mass is often dominated by the largest particles (so-called course mode) with radii near 10 μm. Again nanoparticles are significantly smaller, and in high mass, better for light scattering. Such particles can also serve as water droplet nucleation sites in the troposphere, thus increasing the effective size and scattering of the aerosols. Last, certain nanostructures can be made in a size in which their retention in the stratosphere would be longer, and the relative scattering by weight would be higher, than the non-nanoscale equivalents. Bluth showed that 50 μm particles fall from 10 km in about 12 h, 10 um particles fall in 12 d, while 1 um particles fall in 3-4 years. In comparison sulfate particles have been observed to have a mean radius of about 10 um in one study. Some resonant structures can also be tuned to increase or maximize light scattering while retaining nanometer diameters and long lifetimes in the air. Such materials include such nanorods, fullerenes, nanocrystals, or nanobots, as well as nanocrystaline particles such as fogs or ultrafine nanopowders.

Published estimates suggest that a 1% reduction in incident radiation should be sufficient to counteract the global surface warming, and that when CO₂ concentration is doubled as predicted in the future, a 2% reduction in sunlight is sufficient. Therefore, we created a test chamber, and made measurements in one model system to estimate relative scattering effects and reduction in total incident radiation of 2%. An assumption here is that the total particulate load can be expressed in surface area rather than volume. That is, a photon traveling normally to the earth is as likely to hit a certain mass and number of particles if the particles are spread over a cubic meter versus if they are spread over a meter square on the stratosphere that is 20 km deep (this assumption can be seen from manipulating Beer's law to find a fixed concentration×path length product as the volume is elongated). Therefore, we can extrapolate from a 14″ diameter test chamber to a similar surface area with the depth of the entire stratosphere.

Our test chamber was constructed from 14″ diameter×2 foot long PVC cylinder (schedule 40 PVC pipe, US Plastics, Lima Ohio) that included fan-driven internal wind sources to keep the particles well mixed and aerosolized, and capped with clear acrylic ends (cast disks, Tap Plastics, Stockton Calif.). The total amount of radiation from a narrow beam of broadband white light produced by a 1 cm diameter collimated beam from a halogen lamp was integrated and measured across the enter 24″ window using a NIST-traceable light meter (EXFO Corporation FOT-50 light meter). The goal was to reduce the incident light (transmitted from the source to detector) by the above-mentioned 2% reduction. Light that exits the side or light-source side of the chamber can be assumed to re-escape back to space. Therefore, as a first approximation, the model serves to illustrate the design.

We found that the forward-transmitted light incident on a sensor could be reduced by 2% with only minimal amounts of scattering particle on the order of micrograms per cubic meter. Among the particles we tested were nanopowers of metal and other oxides, including oxides of silicon, titanium, and aluminum. Other nanopowders were sub-micron corn starch, and microscopic 60 um sugar, and polyethylene glycol.

Other confirmatory and modeling studies are in progress, but our results are similar to those results have been achieved in computer models of global cooling by others. In particular, nanoparticles, being in higher number of particles per unit mass as compared to microscopic or lower-limit of visibility particles with a scale of hundreds of microns, are more efficient scatterers, allowing scattering to occur with a lower mass load in the atmosphere.

It is important to note that scattering in the atmosphere leads to an increase in the diffuse range of angles of sunlight reaching the Earth, and that this diffuse scattering caused by Pinatubo is believed to have increased rate of photosynthesis on Earth, rather than decreased it.

The ideal particle size and height of placement in the atmosphere has been considered. In the troposphere, in or below the weather, these agents do not remain long in the atmosphere. Too high, such as a geosynchronous orbit, and these agents last decades or longer, but are expensive to place and cannot be easily called back, as well as pose risk for space objects such as satellites. Ideally, the high stratosphere would allow for affordable deployment, with lifetimes of months to years.

Other devices other than stratospheric aerosols include Earth-based reflectors on ice or water, and space based reflectors that can be tuned to increase or decrease solar flux at will.

Last, it should be noted that geoengineering is not without passionate detractors. Some skilled in the art are vehemently opposed to even trial geoengineering experiments in the environment, and believe that it should be avoided at all costs, at least until better modeling and understanding is developed. Such an unpressured and complete period for evaluation may not be possible given the pace of global warming, and the difficultly to reverse certain effects such as melting of the polar ice caps or the stalling of the arctic/equatorial thermocline. In our view, geoengineering provides remains a plausible and tractable way to counteract global warming, and should be included our present arsenal, and the carbon credit system.

The preceding descriptions of specific embodiments of the present invention have been presented for purposes of illustration and description only. They are not intended to be exhaustive or to limit the invention to the precise forms disclosed. The embodiments were chosen and described in order to explain the principles of the invention and its practical application, to thereby enable others skilled in the art to best utilize the invention and various embodiments with various modifications as are suited to the particular use contemplated. Further variations of the invention will be apparent to one skilled in the art in light of this disclosure and such variations are intended to fall within the scope of the appended claims and their equivalents.

We have discovered a method of business that allows a global cooling company without a product or service that can be delivered to customers, to nonetheless run a sustainable business that obtains sufficient operating capital to operate, and if desired, to become profitable. This method involves the assignment of a carbon-equivalent or other green value to the product or service, for example in the form of a carbon counterbalance credit, which is provided to a first-party global cooling company by second party agencies or governments using a system of tradable emission credits. A transformation occurs in the manufacturing and deployment of a material designed to reduce the incident light upon the Earth, and the business is created by the issuance of credits by a second party tied to a climate, political, economic green metric of the manufacturing and deployment by the first party. These emission credits may be sold or traded with the second or a third party, providing income to sustain the business of the first party. Exemplary systems, devices, and agents for deployment while practicing the business method are also disclosed. These agents have been tested in the lab, or simulated in models. Both the agents and the business method have immediate application to critical and pressing environmental problems, especially to greenhouse gas driven global warming, and thus constitutes an important advance in the art.

What is claimed is:

1. A business method for providing commercial value to a geoengineering global cooling business of a first party, comprising the steps of:
(a) manufacturing or having manufactured an device or agent designed to reduce the incident energy upon the Earth or incident upon its oceans, land masses, or atmosphere;
(b) deploying or having deployed said device or agent; and,
(c) receiving compensation in the form of a tradable credit, wherein said credit is issued as compensation by a second party to the first party in exchange for said reduction in said incident energy; and,
(d) monetizing said credit by selling said credit or exchanging for other valuable instruments to the second or to a third party, such instruments including cash, notes, loans, materials, currencies, or other tradable instruments.

2. The method of claim 1 wherein the agent is a light-scattering optical material deployed in the atmosphere.

3. The method of claim 1 wherein the agent is a light-scattering polymer.

4. The method of claim 1 wherein the agent is a light-scattering nanomaterial, such as a nanopowder, nanorod, nanocrystal, or nanobot.

5. The method of claim 1 wherein the agent is a biodegradable material.

6. The method of claim 1 wherein the tradable credit is a carbon credit.

7. The method of claim 6 wherein the carbon credit is a carbon counterbalance credit.

8. A business method for providing commercial value to a geoengineering business, comprising the steps of:
(a) a first party manufacturing or having manufactured an optical polymer agent designed to reduce the energy incident upon the Earth or incident upon its oceans, land masses, or atmosphere;
(b) deploying or having deployed said polymer agent; and,
(c) receiving compensation in the form of a emission or other tradable credit, wherein said credit is issued as compensation by a second party to said first party in exchange for said reduction; and,
(d) monetizing said credit.

9. A business method for sustaining operation of a geoengineering business of a first party, comprising the steps of:
(a) determining for a given global cooling agent, system, device, or method, the equivalent amount of carbon that would have to be removed from the atmosphere to provide an equivalent effect on global or regional temperature; and,
(b) providing compensation in the form of a tradable credit, wherein said credit is issued as compensation by a second party to the first party in exchange for said equivalent amount of carbon.
